(19) United States
(12) Patent Application Publication
(10) Pub. No.: US 2017/0065494 A1
(43) Pub. Date: Mar. 9, 2017

(54) Oral Medication Delivery System

(71) Applicant: Candice S. Lazar, San Clemente, CA (US)

(72) Inventor: Candice S. Lazar, San Clemente, CA (US)

(21) Appl. No.: 14/845,159

(22) Filed: Sep. 3, 2015

(51) Int. Cl. A61J 17/00

(52) U.S. Cl. CPC A61J 17/006

(57) ABSTRACT

An oral medication delivery system by which to deliver a medication to a user over time, especially a baby or a young child. The medication delivery system includes the combination of a solid dose of oral medication (e.g., a tablet) and a pacifier. The pacifier includes a nipple having a hollow interior within which the oral medication is located and a plurality of perforations formed therein through which the medication is dispensed when the nipple is placed in the mouth of the user to dissolve the medication and the user applies a sucking force to the nipple. The pacifier has a proximal end at which the nipple is located and an opposite distal end that is detachably connected to and separated from the proximal end so that a new dose of oral medication can be located within the nipple to replace a dose which has dissolved in the user's mouth.

### BACKGROUND OF THE INVENTION

1. Field of the Invention

This invention relates to an oral medication delivery system including a pacifier having a nipple and a solid oral medication (e.g. a tablet) that is carried by the nipple and adapted to dissolve in the mouth of a baby or a young child. The nipple has a plurality of perforations through which the medication is dispensed over time when the nipple is placed in the mouth of the baby or young child who then sucks on the nipple.

2. Background Art

A significant problem faced by a youngster who is sick is the inability to sleep for long periods of time. For example, a youngster with a cold may experience cold symptoms and constant coughing throughout the night. The noise and anxiety generated by such coughing is likely to prevent the child's parents from getting a good night sleep as well. While it would be desirable to be able to deliver a medicine to the child to relieve it's coughing and heal its illness, this solution becomes difficult if the medication must be delivered throughout the night. In this case, the parents will be required to frequently wake and leave their bed whenever it becomes necessary to give their child a dose of medication.

Nevertheless, the size of some oral medications is too large to be swallowed easily by a youngster without inducing choking. To avoid a choking reflex, it is known to dip the nipple of the child's pacifier into a liquid medication. However, this solution is only temporary and still requires that the liquid medication be repeatedly applied to the nipple throughout the night.

Accordingly, what would be desirable is an easily refillable oral medication delivery system that is particularly suitable for use by babies and young children so that a dose of medication can be dispensed continuously throughout the day and/or night without subjecting the child to the risk of choking.

### SUMMARY OF THE INVENTION

In general terms, disclosed herein is an oral medication delivery system that is ideal to be placed in the mouth of a baby or young child so that a dose of medication can be dispensed day or night on a continuous basis. In a preferred embodiment, the oral medication delivery system is a pacifier and the oral medication to be dispensed therefrom is a solid (e.g., a tablet) that is adapted to dissolve over time in the mouth of the user. The pacifier has opposing proximal and distal ends that can be disconnected from one another when the oral medication has dissolved in the user's mouth and must be replaced by a new dose.

The proximal end of the pacifier includes a soft, flexible nipple into which the solid oral medication is loaded. The nipple has a plurality of perforations through which the oral medication is sucked after the nipple is placed in the user's mouth and the oral medication dissolves. An outer locking collar surrounds an open end of the nipple through which the oral medication is loaded.

The opposite distal end of the pacifier includes a pull ring that is pivotally connected to an inner locking collar by means of a coupler located therebetween. Once the oral medication has been loaded into the nipple via the open end thereof, the inner locking collar is moved into receipt by the outer locking collar, whereby the proximal and distal ends of the pacifier are detachably connected together. More particularly, a pair of retractable locking tabs are pushed by opposite ends of a coil spring outwardly from respective openings formed in the inner locking collar at the distal end of the pacifier for receipt through axially aligned locking slots formed in the outer locking collar at the proximal end. By virtue of the foregoing, the outer locking collar is locked in surrounding engagement with the inner locking collar to close the open end of the nipple and thereby ready the nipple of the pacifier to be placed in the mouth of the user to receive the medication by way of the perforations formed in the nipple.

### BRIEF DESCRIPTION OF THE DRAWINGS

FIG. 1 shows a first preferred embodiment for an oral medication delivery system of this invention including a pacifier from which an oral medication is dispensed with proximal and distal ends of the pacifier being shown disconnected from one another;

FIG. 2 shows the pacifier of FIG. 1 with the proximal and distal ends thereof connected together;

FIG. 3 is an exploded view of the pacifier shown in FIGS. 1 and 2 in combination with a solid oral medication;

FIG. 4 shows the proximal and distal ends of the pacifier being detachably connected to one another after the solid oral medication has first been loaded into a nipple at the proximal end;

FIG. 5 shows the nipple at the proximal end of the pacifier placed in the mouth of a user by which the medication is dispensed to the user in response to a sucking force applied by the user to the nipple; and

FIG. 6 is an exploded view of a combination pacifier and a solid oral medication for an oral medication delivery system according to another preferred embodiment of this invention.

### DESCRIPTION OF THE PREFERRED EMBODIMENT

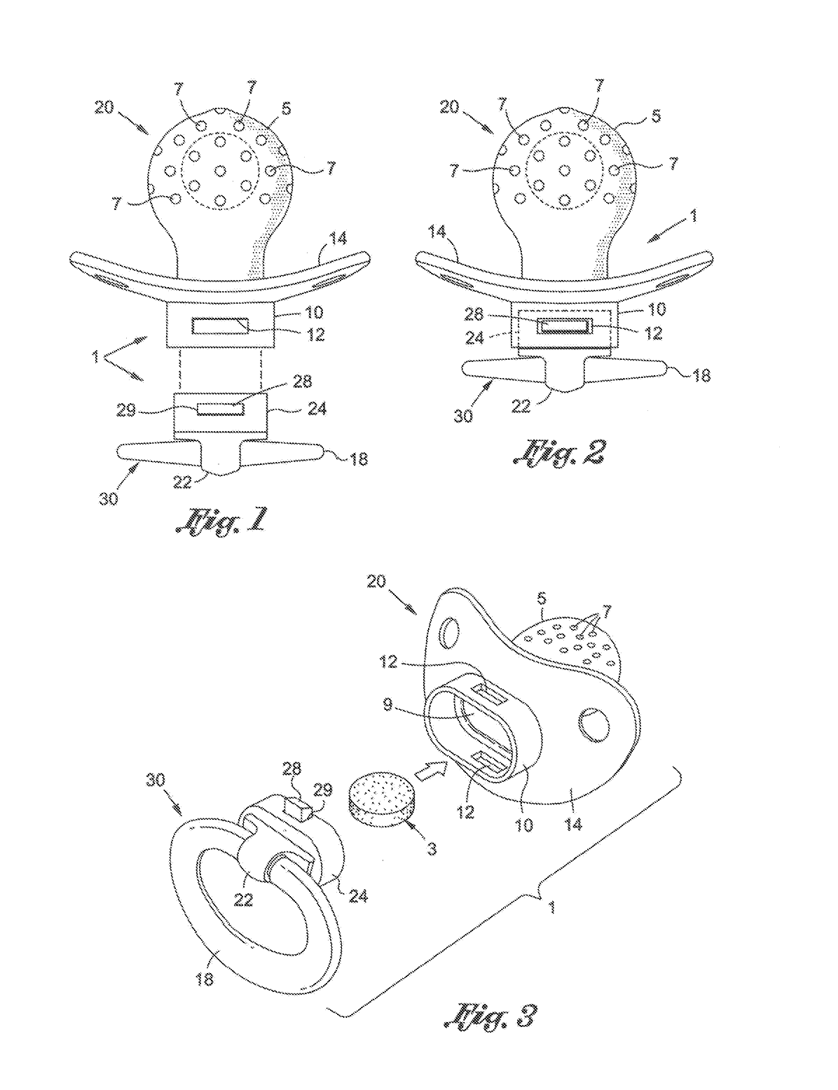

An oral medication delivery system which includes the combination of a pacifier 1 and an oral medication 3 in accordance with a first preferred embodiment of this invention is disclosed while referring concurrently to FIGS. 1-5 of the drawings. As will soon be described, the combination herein disclosed has particular application for dispensing the oral medication into the mouth of an infant or young child. The purpose of the oral medication is not to be considered a limitation of this invention. By way of example only, the oral medication 3 can be used to relieve coughing or reduce a fever of the user.

It is contemplated that the oral medication 3 to be dispensed to the infant or young child has a solid form. In this case, the solid medication 3 has the shape of a tablet. To achieve the advantages of this invention without subjecting the user to choking, the solid medication 3 must be adapted to dissolve in the user's mouth so that it will be delivered to the user over time until the tablet has fully dissolved.

The oral medication 3 is initially loaded into and carried by the pacifier 1 so as to dissolve when the pacifier is placed in the mouth of the user. As an advantage of this invention, once the initial dose of oral medication 3 has partially or fully dissolved, it can be replaced with a new dose of medication to be delivered from the pacifier 1 to the user at a later time.

The pacifier 1 of the oral medication delivery system of this invention has some features which are common to a conventional pacifier on which an infant or young child will suck. That is, the pacifier 1 includes a hollow nipple 5 at a proximal end 20 thereof to be located in the mouth of the user. The nipple 5 is manufactured from a soft, flexible material and shaped to fit comfortably in the mouth of the user. However, unlike a conventional pacifier, and as an important feature of this invention, a plurality of small perforations 7 (e.g. holes or slits) are formed in a closed end of the nipple 5 by which to enable the user's mouth to communicate with and exert a suction force on the interior of the nipple at which the oral medication is carried.

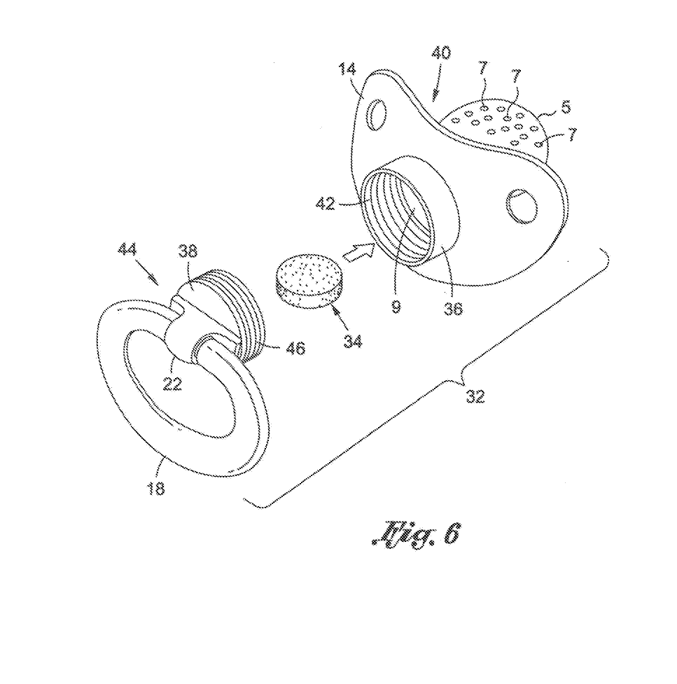

The nipple 5 at the proximal end 20 of the pacifier 1 has an open end 9 which lies opposite the closed end thereof in which the perforations 7 are formed. An oval-shaped outer locking collar 10 surrounds and extends from the open end 9 of the nipple 5. The outer locking collar 10 has a pair of locking slots 12 formed therethrough. A thin and slightly curved mouth guard 14 surrounds the proximal end 20 of the pacifier 1 so as to lie between the nipple 5 and the outer locking collar 10 in order to position the pacifier against the user's lips when the nipple is placed in the user's mouth (best shown in FIG. 5).

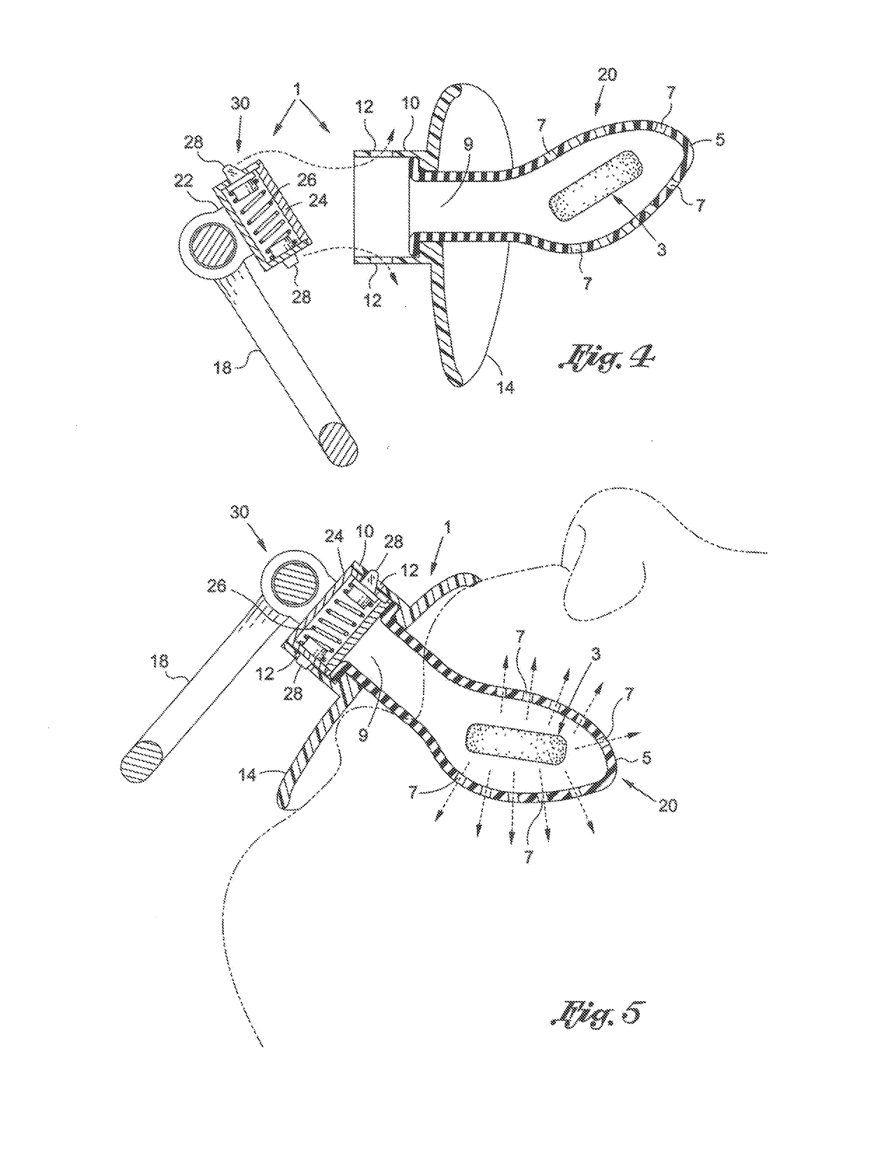

The distal end 30 of the pacifier 1 which lies opposite the proximal end 20 includes the usual pull ring 18 to which a pulling force is applied to remove the nipple 5 from the mouth of the user. The pull ring 18 is pivotably connected to a coupler 22 that is affixed to the outside of an oval-shaped inner locking collar 24. As will now be explained, the inner locking collar 24 at the distal end 30 of the pacifier 1 is adapted to first be connected to and then disconnected from the outer locking collar 10 at the proximal end of pacifier 1 so that the oral medication 3 can be placed inside the hollow nipple 5 via the open end 9 of the nipple (best shown in FIG. 3).

Referring in this regard to FIGS. 1 and 4, the length and width of the oval-shaped outer locking collar 10 is greater than the length and width of the oval-shaped inner locking collar 24. Located at the interior of the inner locking collar 24 is a spring. By way of a preferred embodiment, the spring is a coil spring 26 that runs longitudinally through the interior of locking collar 24. Each of the opposite ends of the coil spring 28 engages a retractable locking tab 28 (best shown in FIG. 4). When the outer and inner locking collars 10 and 24 are disconnected and the proximal and distal ends 20 and 30 of the pacifier 1 are correspondingly separated from one another, the coil spring 26 urges (i.e. pushes) the retractable locking tabs 28 outwardly through respective openings 29 (best shown in FIG. 1) that are formed in the inner locking collar 24.

When the proximal and distal ends 20 and 30 of the pacifier 1 are separated, the oral medication 3 is loaded into the nipple 5 via the open end 9 of the nipple. The proximal and distal ends 20 and 30 are now connected together to hold the oral medication 3 in place and permit the medication to be dissolved and dispensed to the user by way of the perforations 7 when the nipple 5 is inserted into the user's mouth.

More particularly, the smaller oval-shaped inner locking collar 24 at the distal end 30 of the pacifier 1 is moved inwardly of the larger oval-shaped outer locking collar 10 at the proximal end 20. At the same time, the retractable locking tabs 28 will be momentarily pushed inwardly through the openings 29 formed in the inner locking collar 24, and the coil spring 26 will be compressed. Once the outer and inner locking collars 10 and 24 are moved one within the other, the coil spring 26 will expand and the retractable locking tabs 28 will be correspondingly pushed outwardly through the axially aligned openings 29 formed in the inner locking collar 24 and the locking slots 12 formed in the outer locking collar 10. Accordingly, and as is best shown in FIG. 2, the outer locking collar 10 is locked in surrounding engagement with the inner locking collar 10, and the previously open end 9 of the nipple 5 is now closed.

At this point, the pacifier 1 is ready to be used by the infant or young child to continuously dispense the oral medication 3 when the nipple 5 is placed in the user's mouth and the user sucks on the nipple as in the case of a conventional pacifier. When the medication has fully or partially dissolved in the user's mouth, pushing forces being simultaneously applied in opposite directions to the retractable locking tabs 28 will enable the formerly connected outer and inner locking collars 10 and 24 to be disconnected from one another so that a new dose of medication can be loaded into the nipple 5 to enable the pacifier 1 to be reused.

The pacifier 1 that is shown in FIGS. 1-5 includes proximal and distal ends 20 and 30 that are detachably connected together when an oval-shaped outer locking collar 10 at the proximal end 20 is located in surrounding locking engagement with an oval-shaped inner locking collar 24 of the distal end 30. A second preferred embodiment for an oral medication delivery system including a combination pacifier 32 and a solid oral medication 34 is shown in FIG. 6 of the drawings. In this embodiment, the oval-shaped outer and inner locking collars 10 and 24 of the pacifier 1 are replaced by cylindrical outer and inner locking collars 36 and 38 of the pacifier 32. The features that are common to the pacifiers 1 and 32 are identified by identical reference numerals, and no further description thereof will be provided.

The outer cylindrical locking collar 36 at the proximal end 40 of the pacifier 32 has a set of threads 42 running around the interior thereof. The cylindrical inner locking collar 38 at the distal end 44 of pacifier 32 has a complementary set of threads 46 running around the exterior thereof. The diameter of the outer locking collar 36 is larger than the diameter of the inner locking collar 38. Once the oral medication 34 is loaded into the nipple 5 through the open end 9, the proximal and distal ends 40 and 44 will be connected together when the cylindrical inner locking collar 38 is rotated so as to lie inside and be surrounded by the cylindrical outer locking collar 36. That is, the exterior threads 46 of the inner locking collar 38 are rotated into mating engagement with the interior threads 42 of the outer locking collar 36 at which time the pacifier 32 is ready to be used by placing the nipple 5 in the mouth of the user so that medication can be dissolved and continuously delivered from the nipple to the user by way of the nipple perforations 7.

The pacifiers of the oral medication delivery systems herein disclosed have been described as having particular application for delivering an oral medication to a baby or a young child. However, it is to be understood that the pacifiers can also be used by older children and adults who have difficulty swallowing large pills and tablets. In this case, the size of the nipple and the shape of the mouth guard may change depending upon the user and the type of medication to be delivered.

1. An oral medication delivery system by which to deliver an oral medication to a user, said delivery system comprising a hollow nipple within which to receive the oral medication, said nipple having at least one perforation formed therein so that the medication is delivered from said nipple to the mouth of the user by way of said perforation when said nipple is placed in the user's mouth and the user applies a sucking force to said nipple.

2. The oral medication delivery system recited in claim 1, said delivery system further comprising a proximal end at which said nipple is located and an opposite distal end detachably connected to said proximal end, said distal end being disconnected from said proximal end to permit the oral medication to be received by said nipple.

3. The oral medication delivery system recited in claim 2, wherein said nipple has a closed end in which said at least one perforation is formed and an open end for the receipt of the oral medication, the open end of said nipple being closed when the proximal and distal ends of said delivery system are detachably connected together.

4. The oral medication delivery system recited in claim 3, further comprising an outer locking collar extending from one of the proximal or distal ends of said delivery system and an inner locking collar extending from the other one of the proximal or distal ends of said delivery system, said outer locking collar moving into detachable surrounding engagement with said inner locking collar by which said proximal and distal ends are detachably connected together and the open end of said nipple is closed by said distal end.

5. The oral medication delivery system recited in claim 4, wherein said outer locking collar has a first set of threads located at the interior thereof and said inner locking collar has a second set of threads located at the exterior thereof, said outer locking collar being rotated into surrounding engagement with said inner locking collar such that the first set of threads of said outer locking collar are mated to the second set of threads of said inner locking collar.

6. The oral medication delivery system recited in claim 4, wherein said outer locking collar has at least one locking slot formed therein and said inner locking collar has at least one locking tab extending outwardly therefrom; said locking tab being removably received by said locking slot when said outer locking collar is moved into surrounding engagement with said inner locking collar, whereby the proximal and distal ends of said delivery system are detachably connected together.

7. The oral medication delivery system recited in claim 6, wherein said inner locking collar has a hollow interior and at least one opening formed therein such that said at least one locking tab is located in and extends outwardly from the interior of said inner locking collar by way of said at least one opening, said delivery system further comprising a spring located at the interior of said inner locking collar at which to apply a pushing force to said locking tab to urge said locking tab outwardly through the opening formed in said inner locking collar to be removably received by the locking slot formed in said outer locking collar when said outer locking collar is moved into surrounding engagement with said inner locking collar.

8. The oral medication delivery system recited in claim 7, wherein said spring is a coil spring located at the interior of said inner locking collar, one end of said coil spring engaging said at least one locking tab to apply said pushing force to urge said locking tab outwardly through the at least one opening formed in said inner locking collar to be removably received by the at least locking slot formed in said outer locking collar.

9. The oral medication delivery system recited in claim 2, further comprising a pull ring pivotally coupled to one of the proximal or distal ends of said delivery system, said pull ring being responsive to a pulling force applied thereto for pulling said nipple out of the user's mouth.

10. A combination comprising:
a dose of oral medication capable of dissolving in the mouth of a user; and
a pacifier by which to deliver some of the medication to the user, said pacifier including a hollow nipple within which said dose of oral medication is located, said nipple having at least one perforation formed therein so that the medication is delivered from the dose of medication located within said nipple into the mouth of the user by way of said perforation when said nipple is placed in the user's mouth and the user applies a sucking force to said nipple.

11. The combination recited in claim 10, wherein said dose of oral medication is a tablet.

12. The combination recited in claim 10, wherein said pacifier also includes a proximal end at which said nipple is located and an opposite distal end detachably connected to said proximal end, said distal end being disconnected from said proximal end to permit the dose of oral medication to be located within said nipple.
